(19) United States
(12) Patent Application Publication
(10) Pub. No.: US 2017/0235960 A1
(43) Pub. Date: Aug. 17, 2017

(54) INTELLIGENT SYSTEM FOR FORECASTING THREATS IN A VIRTUAL ATTACK DOMAIN

(71) Applicant: James Andrew Austin, Ashburn, VA (US)

(72) Inventor: James Andrew Austin, Ashburn, VA (US)

(21) Appl. No.: 14/986,636

(22) Filed: Feb. 16, 2016

(51) Int. Cl. G06F 21/57; G06N 99/00; G06N 5/04

(52) U.S. Cl. CPC G06F 21/577; G06N 5/04; G06N 99/005; G06F 2221/2101

(57) ABSTRACT

A system for forecasting one or more threats on a Virtual Attack Domain of a Local Area or Wide Area Network, with a system comprising of: at least one Virtual Attack Domain, containing at least one device, as well as a Local Agent System, an External Data Agent, a Super-Agent System, an Internal Archival System, an Internal Parser System, an External Archival System, an External Parser System, an Internal Data Repository, an External Data Repository, an Internal Assets Repository, a Network Traffic Repository, and a Threat Prediction System. The Threat Prediction System comprising of a prediction modeling system, a learning system, and an alerting system. The learning system is responsible for updating the prediction modeling system. An Administrative System enables the selection of a Virtual Attack Domain for generating reports of threat forecast data and alerts and graphical maps representing the patterns and trends of threat forecast data for the selected Virtual Attack Domain.

### I. BACKGROUND ART

Network Security involves defending computer networks against threats. Current technologies try to detect existing threats on computer devices and network assets. Threats can include intrusions and unauthorized uses of resources. As information and communication technology develops, security threats continue to grow in number and type. Known technologies, which detect security existing threats on a network, are described as followed.

The Intrusion Detection System (IDS) is a current type of security system that focuses on detecting existing threats, like viruses, spam emails, computer hacking, Trojan horses, etc. An IDS has a library of threats and monitors the network for existing threats by identifying exact matches of threat data. Or, IDS applies an algorithm on network data to identify potential matches for an existing threat. Whether an IDS uses a library or an algorithm, the system immediately blocks the identified threat or sends an alert to security personnel. The security personnel must react to the current threat by destroying the threat or patching a vulnerability that the threat exposed. In other words, the user must address the vulnerability issue while, or after, the network is being attacked. The IDS system is focused on individual events, working to destroy a current threat and attempting to prevent any identical, or very similar, attack from happening again in the future.

Network Threat Behavior Analysis (NTBA) is another type of security network detection tool. NTBA aggregates data from many points within a proprietary network for offline analysis. After storing an established benchmark for normal traffic, the NTBA program passively monitors incoming network activity and flags unknown, new, or unusual patterns that might indicate the presence of a threat. Network threat behavior analysis is particularly good for identifying new malware and zero day exploits.

Time-series forecasting has emerged as a system for predicting security threats, wherein a user receives an alert of a threat forecasted to occur at a future moment in time. The forecast is used to help users defend the networks against oncoming threats. Time-series is a sequence of data points, typically consisting of a series of measurements made over a specific time value. Time-series forecasting predicts future values based on previously observed sequences of values. Time-series forecasting of computer security threats can be likened to weather forecasting, wherein the temperature for any given day is predicted by using a series of historical temperature data. To update the time-series model, this type of forecasting system measures the differences between the actual results and the predicted results generated by different versions of time-series models. The best model is determined as the one with the smallest margin of error, identified between the actual result and the predicted result.

There is a need for a more dynamic and intelligent system for forecasting future threats.

### II. SUMMARY OF INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The present invention is directed to a threat forecasting system, which uses Threat Prediction Models to transform alert data and log data collected from Internal Networks and vulnerability data collected from External Sources to generate alerts forecasting security events that will threaten a Virtual Attack Domain.

A Virtual Attack Domain (VAD) is created when a user selects a device, or combination of devices, located in an Internal Network. A Central Console selects a VAD and initiates the process of forecasting security events for the VAD. Intelligent Local Agents collect alert data and log data from the devices in the VAD. Intelligent External Agents collect vulnerability data, associated with the VAD, from External Sources in an External Network. The Central Console categorizes the collected alert data, log data, and vulnerability data. A Threat Prediction Model is selected from a Threat Prediction Model Library, where models vary in type. The user picks the Threat Prediction Model that best predicts the type of Threat Activity the user wants to predict for the VAD. The Central Console sends the selected Threat Prediction Model to a Modeling Module where it transforms the categorized alert data, log data, and vulnerability data, all associated with VAD, into a Forecast Value. The Forecast Value is sent to an Alerting Module, where the Alerting Module measures whether the Forecast Value is high enough to send an alert to the Central Console. If it is high enough, the Alerting Module sends the Forecast Value and Alert to the Central Console and the Central Console will transform the Forecast Value and Alert into specialized forecast reports and graphics for the VAD. The specialized threat predictions enable users to create a strategy for the Vulnerability Management and Security Policy for the devices selected in the VAD. In one embodiment, forecast reports also forecast a root cause of the predicted threat, further helping users make informed Security Policy and Vulnerability Management decisions.

Each VAD has a specialized Threat Prediction System, containing the Modeling Module, the Alerting Module, and also a Learning Module. The Learning Module updates the Threat Prediction Model used in the Modeling Module. The Learning Module transforms incoming alert data, log data, and vulnerability information from a particular VAD into a Trigger by using the Threat Prediction Model, also used in the Modeling Module, in combination with other pre-established rules and metrics. The Trigger alerts the need for updating the Threat Prediction Model that is currently generating forecasts for the VAD. The rules and metrics of the Learning Systems differentiates the incoming alert data, log data, and vulnerability data by organizing them into pre-established sub-categories of data and giving each sub-category a different weight of significance. Because of the rules and metrics, the Triggers are attuned to a variety of variables that affect the threat predicted by the Threat Prediction Model. The Triggers, as a result, help to generate more refined forecasts of a threat for a VAD.

A Management Server generates an encryption key, also called e-key, which secures the data transfer between the Devices in the Internal Network and the Threat Prediction Server, containing the Threat Prediction System and the Central Console. The e-key protects all the systems in the Threat Prediction Server from being infected by potentially compromised data collected from the End Device.

### III. BRIEF DESCRIPTION OF DRAWINGS

FIG. 1 is a view showing the construction of an intelligent system for forecasting threats on a Virtual Attack Domain, according to an exemplary embodiment of the present invention.

FIG. 2 is a view showing the construction of the Internal Network Intelligence Collection Unit, according to an exemplary embodiment of the present invention.

FIG. 3 is a view showing the construction of the External Network Intelligence Collection Unit, according to an exemplary embodiment of the present invention.

FIG. 4 is a view showing the Management Server 400 generating an e-key and sharing it with the device 204 and the Threat Prediction Server 100 to secure all data transfers, according to an exemplary embodiment of the present invention.

FIG. 5 is a flowchart showing the application of a Threat Prediction Model to log, alert, and vulnerability data, associated with a Virtual Attack Domain, to generate threat forecast data, according to an embodiment of the system described herein.

FIG. 6 is a flowchart generating a Threat Prediction Model for an intelligent threat forecasting system, according to an embodiment of the system described herein.

FIG. 7 is a flowchart showing a Learning Module 142 generating a Trigger for updating the Threat Prediction Model used by the Modeling Module 144 to generate forecast data for a Virtual Attack Domain, according to an embodiment of the system described herein.

### IV. DESCRIPTION OF EMBODIMENTS

An intelligent system for forecasting threats on a Virtual Attack Domain, according to the present invention, will be described more fully hereinafter with reference to the accompanying drawings, in which exemplary embodiments of the invention are shown.

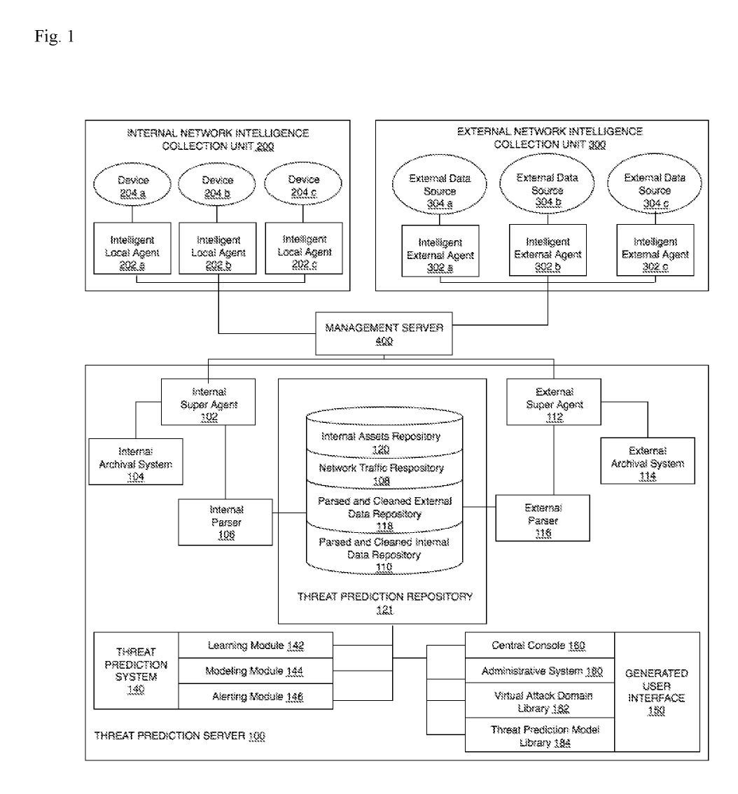

FIG. 1 is a view showing the construction of an intelligent system for forecasting threats on a Virtual Attack Domain, according to an exemplary embodiment of the present invention.

Referring to FIG. 1, An intelligent system for forecasting threats on a Virtual Attack Domain, according to the present invention, comprises of, an Internal Network Intelligence Collection Unit 200, an External Network Intelligence Collection Unity 300, a Management Server 400, and a Threat Prediction Server 100.

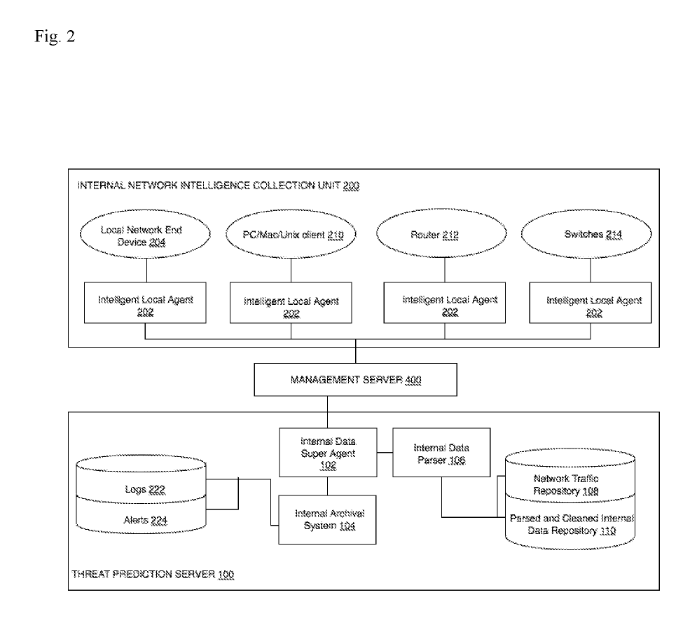

An Internal Network Intelligence Collection Unit 200 collects log data and alert data from one or a plurality of devices 204 contained within an Internal Network. Please refer to FIG. 2 for an in depth description of these processes.

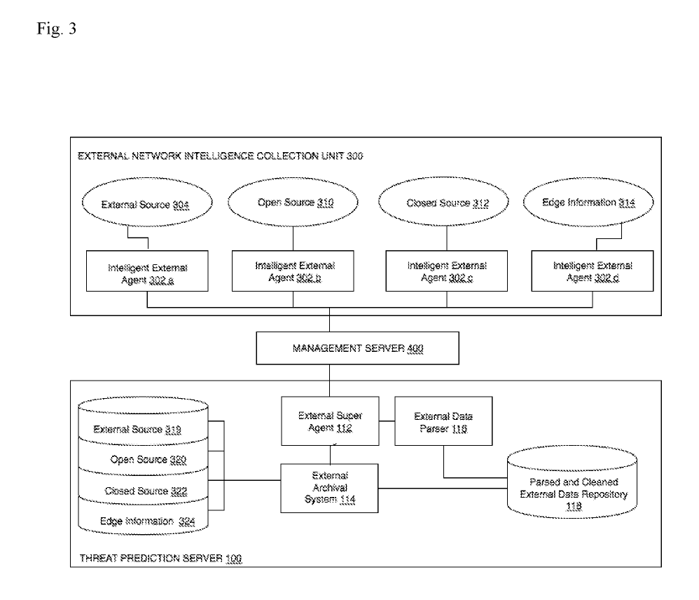

An External Network Intelligence Collection Unit 300 comprises of one or a plurality of Intelligent External Agents 302 and one or a plurality of External Data Sources 304, provided by an External Network. Please refer to FIG. 3 for an in depth description of these processes.

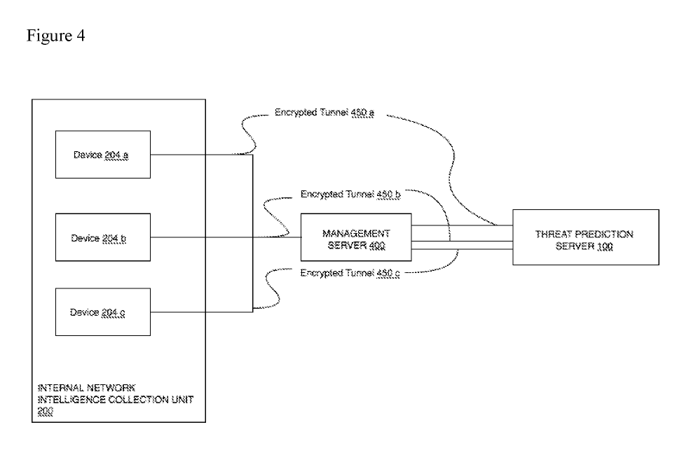

A Management Server 400 is the management and control center for the Local and External Intelligent Agents, 202 and 302. It creates the rules and procedures for the Intelligent Local Agents 202 to collect alerts and log data from the devices 204 in the Internal Network. The Management Server 400 also could create the rules and procedures for the Intelligent External Agents 302 to collect vulnerability data from the External Data Sources 304 in the External Network. The Management Server 400 generates an e- key for each device 204 in the Internal Network to secure all data transfers between each device 204, the Management Server 400, and the Threat Prediction Server 100. An e-key is a cryptographic key that is generated by using a proprietary algorithm in an encryption process that is further described at FIG. 4. The Management Server 400 is responsible for receiving and storing the processed alerts and log data obtained from the devices 204 and the processed vulnerability data obtained from the External Data Sources 304.

A Threat Prediction Server 100 is one or a plurality of processors, which connect to the Management Server 400, through an e-key encrypted communication tunnel, and contain the systems required to deliver the threat forecasts. The Threat Prediction Server 100 comprises of an Internal Super-Agent 102, an External Super-Agent 112, an Internal Archive System 104, an External Archive System 114, an Internal Parser 106, an External Parser 116, a Threat Prediction Repository 121, a Threat Prediction System 140, and a Generated User Interface 150.

The Threat Prediction Repository 121 comprises of: the Network Traffic Repository 108, the Parsed and Cleaned Internal Data Repository 110, the Parsed and Cleaned External Data Repository 118, and an Internal Assets Repository 120.

The Threat Prediction System 140 contains three modules: a Learning Module 142, a Modeling Module 144, and an Alerting Module 146. The Modeling Module 144 transforms data collected in the Threat Prediction Repository 121 into Forecast Data by using a Threat Prediction Model, selected from a Threat Prediction Model Library 184. The Alerting Module 146 determines whether the Forecast Data meets certain thresholds to send an alert to a Generated User Interface 150 by using previously defined rules and metrics. The Learning Module 142 updates the Threat Prediction Model used in the Modeling Module 144 to refine the forecasting results to focus on specific threats.

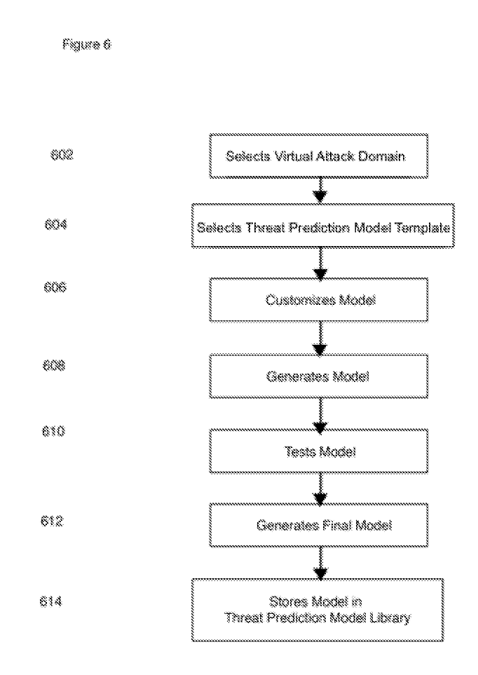

The Generated User Interface 150 contains a Central Console 160, an Administrative System 180, a Virtual Attack Domain Library 182, and a Threat Prediction Model Library 184. The processes of creating, customizing, generating and storing one or a plurality of Threat Prediction Models in the Threat Prediction Model Library 184 are described in FIG. 6. The super-user can use the Generated User Interface 150 to assign Threat Prediction Models to the Modeling Module 144, assign Threat Prediction Models and rules and metrics to the Learning Module 142, and also assign rules and metrics to the Alerting Module 146. The Administrative System 180 allows a super-user the highest level of access to updating the systems on the Threat Prediction Server 100. Updating systems includes defining rules and procedures for the Internal Super-Agent 102 and the External Super-Agent 112, defining the rules and procedures of the Internal Archival System 104 and the External Archival System 114, and defining the rules and procedures for the Internal Parser 106 and the External Parser 116. In one embodiment, the Administrative System 180 is responsible for adding a new device 204 identifiable in the Internal Network, adding a new identifiable External Data Source 304, adding a new Intelligent Local or External Agent 202 or 302, creating the rules and metrics for the Alerting Module 146, and creating rules and metrics for the Learning Modules 142.

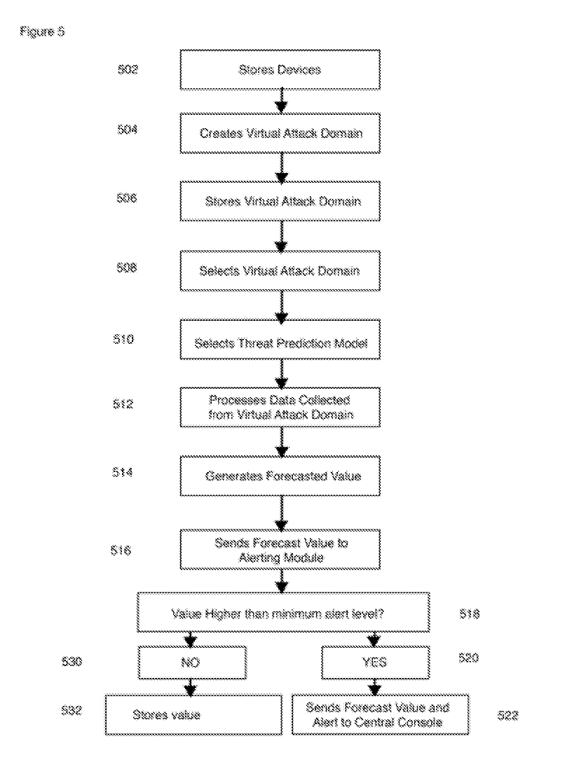

The Central Console 160 creates one or a plurality of Virtual Attack Domains on the Threat Prediction Server 100. The Virtual Attack Domain is created when a user selects a device 204, or a combination of devices 204, located in an Internal Network, and stores the selection of devices in the Virtual Attack Domain Library 182. The Virtual Attack Domain Library 182 will collect and report the threat data that the forecasting system creates for each Virtual Attack Domain. FIG. 5 illustrates how the Central Console 160 selects the Virtual Attack Domain to generate specific threat forecast data results.

FIG. 2 is a view showing the construction of the Internal Network Intelligence Collection Unit, according to an exemplary embodiment of the present invention. An Internal Network Intelligence Collection Unit 200 comprises of one or a plurality of Intelligent Local Agents 202 and one or a plurality of devices 204 in an Internal Network. An Internal Network is one or a plurality of devices 204 connected wirelessly, directly, or by other means inside of an organization. A device 204 is any machine that can process computer data. Intelligent Local Agents 202 collect and process alert and log data from each device 204 as per the rules and procedures established by the Management Server 400. Intelligent Local Agents 202 also ensures communication of the collected alert and log data to the Management Server 400.

The log data may be sourced from the operating system logs or may be generated directly by the Intelligent Local Agents 202. One example of a rule might be that the Intelligent Local Agents 202 would collect all the log data regarding invalid log in and log out event data on a device 204 or log in and log out data on a device 204 that meets specific thresholds and would constitute alerts. In another example, a rule might be that the Intelligent Local Agents 202 would collect all log data that meet specific patterns that were previously identified.
The Internal Data Parser 106 applies the rules and procedures to parse and clean the data brought by the Internal Super-Agent 102 from the Management Server 400 and then stores the data in the Network Traffic Repository 108 and the Parsed and Cleaned Internal Data Repository 110.
The Internal Archival System 104 applies the rules and procedures to archive the data brought by the Internal Super-Agent 102 from the Management Server 400 and then stores the data in Logs 222 and the Alerts 224 Repositories.

FIG. 3 is a view showing the construction of the External Network Intelligence Collection Unit, according to an exemplary embodiment of the present invention. An External Network Intelligence Collection Unit 300 comprises of one or a plurality of Intelligent External Agents 302 and one or a plurality of External Data Sources 304, provided by an External Network. An External Network is one or a plurality of devices outside of an organization's Internal Network, but connected to at least one of the devices in the Internal Network through the Internet. An External Source 304 is any source accessible via the Internet by a device 204 in the Internal Network, which provides information about a potential threat or vulnerability that could affect any of the devices 204 contained within the Internal Network.

The Intelligent External Agents 302 collect and process vulnerability data from each External Data Source 304 as per the rules and procedures established by the Management Server 400. The Intelligent External Agents 302 also ensure communication of the collected vulnerability data to the Management Server 400.
One example of a rule for an Intelligent External Agent 302 might be to access the National Vulnerability Database provided by the U.S. Government's National Institute of Standards and Technology, through the Internet at nvd.nist.gov, for vulnerabilities particular to the devices 204 in the Internal Network. Another example of a rule for an Intelligent External Agent 302 might be to access news sources at www.twitter.com, created by certain organizations that are trustworthy in the vulnerability and security arena and provide data related to the security of devices 204 in the Internal Network.

External Sources 304 provide the benefit of delivering threat news and information in real-time to the intelligent system for forecasting threats on a Virtual Attack Domain.

The External Data Parser 116 applies the rules and procedures to parse and clean the data brought by the External Super-Agent 112 from the Management Server 400 and then stores the data in the Parsed and Cleaned External Data Repository 118.
The External Archival System 114 applies the rules and procedures to archive the data brought by the External Super-Agent 112 from the Management Server 400 and then stores the data in the Open Source 320, Closed Source 322, Edge Information 324, and External Source 319 Repositories.

FIG. 4 is a view showing the Management Server 400 generating an e-key and sharing it with the device 204 and the Threat Prediction Server 100 to secure all data transfers, according to an exemplary embodiment of the present invention. The e-key is encrypted using a propriety algorithm. When the Management Server 400 generates the e-key both the device and the Management Server 400 must know each other's portion of the associated key. The same would apply when the Management Server 400 and the Threat Prediction Server 100 want to communicate.

FIG. 5 is a flowchart showing the application of a Threat Prediction Model to log, alert, and vulnerability data, associated with a Virtual Attack Domain, to generate threat forecast data, according to an embodiment of the system described herein. At step 502, the Central Console 160 identifies one or a plurality of devices 204 in an Internal Network Intelligence Collection Unit 200 and then stores the identified devices 204 in the memory. Processing proceeds to step 504 at which the Central Console 160 creates one or a plurality of VADs by selecting one or a plurality of Devices 204 from the Internal Network Intelligence Collection Unit 200, identifying the one or group of devices 204 as a Virtual Attack Domain, and storing the identified Virtual Attack Domain 506 to the memory of the Virtual Attack Domain Library 182, introduced in FIG. 1.

At step 508, the Central Console 160 selects a VAD from the VAD Library 182, which generates a report to the Generated User Interface 150 listing the categories of devices 204, types of device data on each of the devices 204, and External Sources 304 providing vulnerability data associated with the selected VAD. At step 510, the Central Console 160 selects a Threat Prediction Model from the Threat Prediction Model Library 184, generated in a process illustrated at FIG. 6. The system processes the selection of a Threat Prediction Model and assigns it to the selected VAD. The model is selected by a user specifically to fit the categories of devices, the types of device data, and the vulnerability data associated with the selected VAD. The Threat Prediction Model is also selected to determine a threat that the user specifically wants to forecast for the selected VAD. Processing proceeds to step 512, where the selected Threat Prediction Model is applied onto the collected device data and vulnerability data associated with the VAD to generate Forecast Data 514. The Modeling Module 144 then sends the generated Forecast Data to the Alerting Module 516, where pre-established rules and procedures are stored to determine whether the generated Forecast Data is less than, equal to, or more than a minimum Alert Level 518. If the rules and procedures determine that the forecast is less than the minimum alert level 530, then, in one embodiment, the forecast data is stored 532. If the rules and procedures determine that the forecast data is equal or higher than the minimum alert level 520, then an alert and the forecast data are stored in the memory for retrieval in the VAD Library 182 and sent to the Central Console 522.

In the Alerting Module 146, at step 516, rules and procedures and minimum alert levels can vary depending on the Threat Prediction Model and VAD. For each VAD, there might be more than one minimum alert value applied to each Threat Prediction Model.

The Central Console 160 transforms the alerts and forecast values from the VADs into reports and graphs, providing not only the alert data and forecast values but also threat trends and patterns forecasted to occur in a VAD. In another embodiment, the Administrative System 180 can apply rules and procedures to the Forecast Data and alerts to identify the root cause of the threat forecasts.

FIG. 6 is a flowchart generating a Threat Prediction Model for an intelligent threat forecasting system, according to an embodiment of the system described herein. Processing begins at step 602, where the Central Console 160 selects a VAD from the VAD Library. Processing proceeds to step 604, where a super-user selects a Threat Prediction Model Template from a Threat Prediction Model Library 184, introduced in FIG. 1, to be applied onto the selected VAD, from previous step 602. The Templates in the Threat Prediction Model Library 184 include, but are not limited to, the following types of predictive mathematical models: Group method of data handling, Naïve Bayes, k-nearest neighbor algorithm, majority classifier, support vector machines, random forests, boosted trees, Classification and Regression Trees, Multivariate adaptive regression splines, Neural Networks, ACE and AVAS, Ordinary Least Square, Generalized Linear Models, Logistic regression, Generalized additive models, Robust regression, and Semiparametric regression. The Threat Prediction Model Template is selected to fit the type or types of devices contained within the selected VAD, the types of device data on each of the devices of the VAD, the external sources providing vulnerability data associated with the selected VAD, and the type of threat the user wants to forecast. Processing proceeds to step 606, where the Central Console 160 customizes the Threat Prediction Model Template to fit the model and consider the types of data identified on the selected device type, or device types, as well as the threat that the user wants to forecast. Processing proceeds to step 608, where the Central Console 160 generates the customized Threat Prediction model and performs testing and fine-tuning of the model 610. Processing then proceeds to step 612, where the Central Console 160 generates the final Threat Prediction Model. Processing proceeds to step 614, where the Central Console 160 stores the final model in the Threat Prediction Model Library 184 for future use.

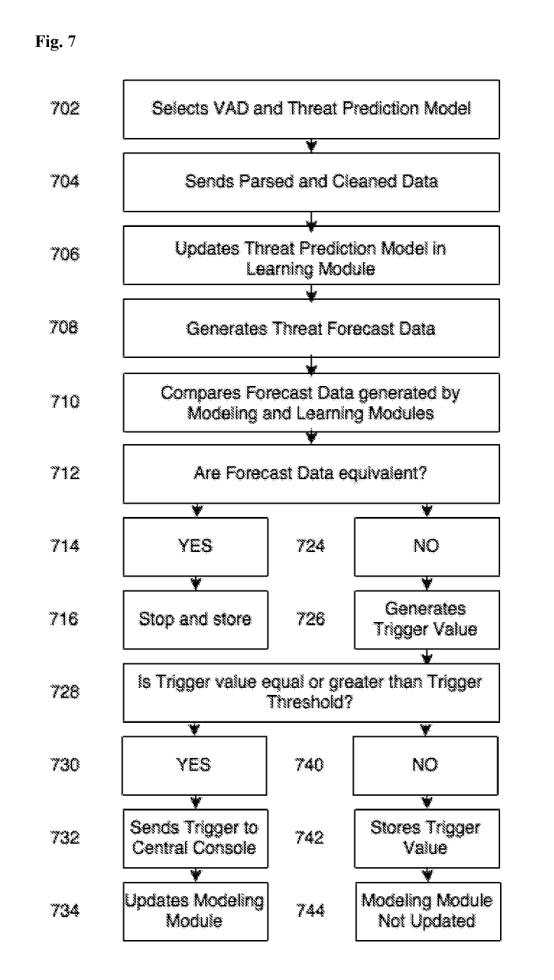

FIG. 7 is a flowchart showing a Learning Module 142 generating a Trigger for updating the Threat Prediction Model used by the Modeling Module 144 to generate forecast data for a Virtual Attack Domain, according to an embodiment of the system described herein. Processing begins at step 702, wherein the Central Console 160 selects a VAD from the VAD Library 182 and assigns a Threat Prediction Model from the Threat Prediction Model Library 184 to the selected VAD. The Central Console 160 sends the same Threat Prediction Model to the Modeling Module 144 and the Learning Module 142. The Modeling Module 144 and the Learning Module 142 herein out work in parallel to one another. Whereas the Modeling Module 144 is dedicated to generating official threat forecast data for the user, the Learning Module 142 is dedicated to testing and assessing whether the most up to date Threat Prediction Model used in the Modeling Module needs to be updated with the latest incoming data, or not. At step 704, the Threat Prediction Repository 121 sends the latest parsed and cleaned assets, log, alert, and vulnerability data, pertaining to the devices identified in the selected VAD, to the Learning Module 142 and Modeling Module 144. Processing proceeds to step 706, wherein the Learning Module 142 updates its Threat Prediction Model, used for learning, with the new incoming data. In step 708, the Learning Module 142 applies the newly updated Threat Prediction Model to the new incoming collected asset, log, alert, and vulnerability data and generates threat forecast data for learning purposes. At step 710, the Learning Module 142 compares the forecast data from step 708 with the forecast data generated by the Modeling Module 144 at step 514, seen in FIG. 5. If the Learning Module 142 determines that the forecast data generated by the two modules 142 and 144 are equivalent at step 712, processing proceeds to steps 714 and step 716, wherein the Modeling Module 144 is not updated to include the latest data from Learning Module 142. If the Learning Module 142 determines that the forecasts generated by the two modules 142 and 144 are different, processing proceeds to steps 724 and 726, wherein the Learning Module 142 generates a Trigger Value. If at step 728, pre-established rules and procedures in the Learning Module 142 determine that the Trigger Value is equal or higher than a pre-established Trigger threshold, processing proceeds to steps 730, 732, and 734, wherein the Modeling Module 144 updates its Threat Prediction Model by adopting the latest Threat Prediction Model from the Learning Module 142. More, the Trigger Value is sent to the Central Console 160 to alert a super-user that the Threat Prediction Model in the Modeling Module 144 has been updated. If at step 728, pre-established rules and procedures in the Learning Module 142 determine that the Trigger Value is below a pre-established Trigger threshold, processing proceeds to steps 740, 742, and 744, wherein the Trigger data is stored and the Learning Module 142 does not update the Modeling Module 144 to reflect the latest incoming data.

The Background Art, the Summary of Invention, the Figures and Drawings, and the Description of Embodiments have described illustrative embodiments of the invention. However, the foregoing illustrative embodiments have been used only as an examples and it is understood that there are numerous changes in the details of implementation that can be made without departing from the spirit and the scope of the invention, which is only limited by the claims, which follow. Features of the disclosed embodiments can be combined and rearranged in various ways.

1. A system for forecasting one or more threats on a Virtual Attack Domain of a Local Area or Wide Are Network, with a system comprisingo f:
1. A Virtual Attack Domain for selecting at least one device within a Local or Wide Area Network. At least one Local Agent System for collecting system log file data and system alert data from the device, or devices, identified in the Virtual Attack Domain. A Super-Agent System for collecting system log file data and system alert data from the at least one Local Agent System and for transmitting, through at least one encrypted tunnel, the system log file data and alert data to an internal Data Archival System and to an Internal Data Parser System. The Internal Data Parser System for parsing the system log file data and system alert data and for storing the system log file data and system alert data in an Internal Data Repository and in a Network Traffic Repository;
2. An External Data Agent System for collecting vulnerability data from at least one open source information system, closed source information system, or edge information system, accessed through an internet connection, and for transmitting the vulnerability data to an External Data Archival System and an External Data Parser System. An External Data Parser System for parsing the vulnerability data and for storing the parsed vulnerability data in an External Data Repository. A Threat Prediction System for learning, prediction modeling and alerting forecasted threat data with system log file data, system alert data and vulnerability data in real-time from the Internal Data Repository, the Network Traffic Repository, External Data Repository and an Internal Assets Repository;
3. The said Threat Prediction System is comprised of:
a. A prediction modeling system applying a mathematical prediction model on historic and real-time system log file data, system alert data, and vulnerability data from the Internal Data Repository, the Network Traffic Repository, the External Data Repository and an Internal Assets Repository of the Virtual Attack Domain for generating threat forecast data;
b. A learning system applying a mathematical prediction model on historic and real-time system log file data, system alert data and vulnerability data from the Internal Data Repository, the Network Traffic Repository, the External Data Repository, and the Internal Assets Repository of the Virtual Attack Domain for generating threat forecast data for learning and Trigger Data for updating the said prediction modeling system;
c. An alert system applying rules and procedures to the threat forecast data generated by the said prediction modeling system and sending an alert to the central administrative system if the threat forecast data is equal to or greater than a predetermined threat forecast data threshold. This system is a central administrative system for selecting a Virtual Attack Domain for generating reports of threat forecast data and alerts and graphical maps representing the patterns and trends of threat forecast data for the selected Virtual Attack Domain.
